(19) United States
(12) Patent Application Publication
(10) Pub. No.: US 2009/0193862 A1
(43) Pub. Date: Aug. 6, 2009

(54) LOCK WITH COMBINATION PINS OF NON-CIRCULAR SECTION AND ECCENTRICITY CAPABLE OF BEING POSITIONED IN ROTATION AND LOCK KEY WITH COMBINATION INDENTATIONS DIFFICULT TO REPRODUCE FRAUDULENTLY

(75) Inventors: Jose ALCELA Y BEA, Irun (ES); Ugutz TELLECHEZ HUALDE, Irun (ES)

Correspondence Address: EGBERT LAW OFFICES, 412 MAIN STREET, 7TH FLOOR, HOUSTON, TX, 77002, US

(73) Assignee: TALLERES DE ESCORIAZA, S.A., Irun (Guipuzcoa) (ES)

(21) Appl. No.: 12/363,770

(22) Filed: Feb. 1, 2009

(30) Foreign Application Priority Data
Feb. 5, 2008 (ES) 200800309
Dec. 11, 2008 (ES) 200803517

(51) Int. Cl. E05B 25/08

(52) U.S. Cl. 70/383

(57) ABSTRACT

The present invention proposes a lock with combination pins of non-circular section and eccentricity capable of being positioned in rotation, according to which the seatings or housing orifices for the pin-counterpin sets are aligned. At least one of these same orifices in the rotor two semi-pins are housed together, abutting each other and being provided with respective eccentric tips. The eccentric tips of the pair of semi-pins housed in a same orifice are capable of operating in combination indentations belonging to a same or to two different rows of cuts provided in the shaft of the key. The semi-pins of which have paraxial projections, which are reciprocal with corners formed in the transversal section of the orifice corresponding to the seating. Each semi-pin has a counterpin associated with it, which is mounted against a spring.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention relates to a lock of the type which for the opening combination uses pin-counterpin sets which are located in seatings or housings which are determined by orifices provided through the stator and the rotor of the cylinder which is activated by the turn of a key the shaft of which is inserted in said rotor.

This invention relates to a system for cutting, so as to make them difficult to reproduce fraudulently, the combination indentations in blades of keys for locks which use pin-counterpin sets established in respective combination seatings which are aligned in one or two rows in the body of the cylinder of the lock.

2. Description of Related Art Including Information Disclosed Under 37 CFR 1.97 and 37 CFR 1.98.

Cylinders are known which comprise a rotor and stator and with housing orifices of combination pins, which go through the stator and rotor. In each of the seatings or orifices, are housed a pin and a counterpin (or drive pin).

Among such cylinders are known those in which each orifice uses respective cylindrical pins (and their respective counterpins) which, therefore, can turn freely therein without having a fixed and specific rotary position, which requires their tip to be centered according to its turning axis to ensure its operating performance with respect to the indentation cut for the purpose in the shaft of the key.

Cylinders are also known in which said orifices have a transversal section form such that it impedes its turn, that is to say, that they have a fixed rotary position and the pin-counterpin sets can only move up and down along the orifice thereof.

In these two cited types, the common characteristic is that in each orifice of the rotor, there is a single pin, which has its respective counterpin in the stator.

In a different context, cylinders are also known which use revolving pins with various forms of tip in contact with the key. This makes copying the key difficult, but at the expense of there being only a single valid pin for each form and height of the cut of the key.

Another principle achieved in this field, and which is in some way implicit in everything said in this point, is that in the cylinders known for each combination seating there is a single valid pin and it is not possible to mount a different one other than the one which was custom-made for the engraving of its key.

One in particular of the recent methods of succeeding in fraudulently opening locks is known as “bumping”, based on knowledge and analysis of the system used by a cylinder. It involves seeing the position of the pins in the cylinder and, subsequently, knowing the cuts of the key and its possible heights. With this an expert or a thief can make a false key, which, inserted in the cylinder and bumping on it, can cause the violent opening thereof.

Numerous models of keys are known on the market, which in their blades or bits demonstrate a wide variety of different cuts. Most of these keys, of the order of 9 out of 10, are used in the most common way, as keys different from one another, which are only valid for opening a specific cylinder. The rest of these keys are used for master keying, where a key can open more than one cylinder, and vice versa, a cylinder can be opened by more than one key. Keys in common use always have a same number of cuts and in fixed positions for each type of key, master keys may have more cuts, but always in a fixed and known position, according to the type of key and cylinder.

According to which is the face of the blade in which the cuts are made, there are keys called “toothed” keys which have the main combination cuts in the thin face of the blade and possibly another in the wide face (in the form of a point, step or channel) to add some additional condition of greater anti-copying or anti-opening security of the cylinder, when it is the wide face which has the cuts the key is called “flat”.

In both cases, in that of the flat key, more commonly two rows of cuts may exist. To make copying these cuts difficult, they are of conical form, or other forms, and are made with different depths, but always respecting the condition of being made in fixed and, therefore, known positions.

Another way of making copying difficult is to incorporate in the blade additional fixed or moving elements which, to the same conditions imposed by cuts in fixed and known positions of the blade, add others of recognizing a particular type of key, so that if these are not recognized, it will not be possible to validate the opening combination cut in the blade. The known and patented solutions in this regard are difficult to implement, expensive and are prone to producing faults and malfunctions.

Moreover, in the market there exist key blanks, which are keys like the different existing types which are only missing the combination cut. Whenever, according to what has been said thus far, the cuts occupy fixed and known positions in the blade of each type of key belonging to a range of keys produced in series, it is feasible to make fraudulent copies of keys. Also, these fixed and known positions of the cuts of the blade enable the use of fraudulent opening procedures which are based on the preparation of false keys which succeed in opening the cylinder by means of techniques such as “bumping”, consisting in repeatedly knocking the false key inserted in the cylinder, at the same time as applying rotational pressure on it, so that a moment is encountered in which all the pins together are raised against the spring thereof further away from the plane of rotation of the rotor of the cylinder, enabling the latter to turn in the direction of opening of the cylinder.

Also known are keys which in the blade have non-rectilinear trajectory grooves cut and which in all their extension, width and depth are constant. These grooves operate like a track in which tightly slide a plurality of lateral projections of a plurality of pieces through which the opening combination is determined.

### BRIEF SUMMARY OF THE INVENTION

Faced with this state of affairs, this invention proposes a lock with combination pins of non-circular section and eccentricity capable of being positioned in rotation, according to which the seatings or housing orifices for the pin-counterpin sets are aligned according to the longitudinal median plane of the cylinder of the lock. Although, the invention can also be implemented on double row cylinders, and are bored with a transversal section which is not circular but circumscribed to a cylinder the diameter of which has sliding adjustment with regard to that of conventional revolving pins which do not have a marked rotatory position, and in at least one of these same orifices in the rotor two semi-pins are housed together, abutting each other, which are provided with respective eccentric tips and which in their combined outline are complementary with regard to said transversal section of the orifice which is provided for the purpose through the stator and the rotor of the cylinder reaching the key entry channel in said rotor. The eccentric tips of the pair of semi-pins housed in a same orifice are capable of operating in combination indentations belonging to a same or to two different rows of cuts provided in the shaft of the key, and the semi-pins of which have paraxial projections which are reciprocal with corners formed in the transversal section of the orifice corresponding to the seating, and where each semi-pin has a counterpin associated with it which is mounted against a spring. In this formation, the semi-pins of each orifice have a different length and, with the exception of their paraxial projections, these two semi-pins together form a cylindrical outline with the diameter of a circular pin of the conventional type and are abutting each other according to a diametric plane thereof.

This formation enables two pin elements (which have been called semi-pins), which are capable of operating as two independent pins, to be mounted together, but with the distinguishing feature of doing so in a housing which serves also for a conventional revolving pin, since the corners formed in the transversal section thereof do not diminish the perfect fit of the greater part of the outline of said revolving pin and the latter can perform its function completely normally. From which, it is deduced that with the new invention it is now possible that in a same seating of the cylinder these two types of pins, as a minimum, can be mounted. The conventional revolving type with centered tip and the non-revolving type split into two semi-pins which is now being proposed.

By extension it is obvious that in said seating any other type of non-revolving type of pin can be mounted, provided that the outline (except for the paraxial projections) has an operating diameter corresponding to that of a housing in a conventional cylinder. For example, pins in one piece with two heads at a different height, or pins in one piece with a variable position eccentric tip (for example, each 45° and at two or more different distances from the axis of the pin), or with a specially machined tip for operating on one or the other, including both together, of two rows of cuts of the key.

Other features of this invention are that it is valid for both toothed keys and flat keys, which, moreover, may have two, three or more rows of cuts, which, furthermore, can present different distances to the head of the key, in clear contrast with what is currently normal: that this distance is fixed.

From what has been presented at this point, significant advantages are evident. On the one hand, the number of possible combinations is enormously increased by the great variety of pins it is possible to mount in a same seating. Whereas in a traditional cylinder system for each seating of the key it is only possible to cut a limited number of different heights, with the lock system now proposed for each such height there exists the additional possibility of changing the position of said cut according to which is the eccentric tip and the orientation thereof which is going to operate on the latter. If added to this, that in a same cylinder different types of the pins mentioned can co-exist, in a random (but predetermined) manner, one in one seating and a different one in another seating, practically impenetrable security can be achieved for the sophisticated methods of violation used, including the aforementioned “bumping”.

On the other hand, the stator and rotor of the cylinder of the lock according to the invention are totally interchangeable with those of cylinders already known to exist on the market. Moreover, the stator and cylinder rotors existing on the market can be easily adapted to the new system simply by adding a broach of the housings with the form of the new pins, basically with respect to the forming of the corners provided for the coupling of the paraxial projections intended to impede the turning of these new pins, marking the specific fixed rotary working position thereof.

Furthermore, the lock according to the invention enables more modular and versatile production, since the decision on the pin to be mounted in each seating can be made at the time it is mounted, thus allowing any of the types according to the invention to be selected or, also, combining them with conventional ones when the application demands a lower level of requirements, which offers the additional feature of much greater levels of security and sophistication than current mid-level and medium-priced but very widely used locks.

This invention proposes a lock key with combination indentations difficult to reproduce fraudulently, of the type which have at least one row of combination seatings which operate with the pin-counterpin sets housed in the orifices of the cylinder, comprising a stator and a rotor, and designating a median plane of pins and counterpins to the plane which contains the axes of the cylindrical part thereof and which would also be the plane which would contain the combination indentations of the key if the pins were not off-center on their active tip. In the blade of the key, an irregular sinuous channel is cut with respect to the median plane of pins, this channel in each transversal section has a variable width and, at least, a variable depth of independent size between them. The irregular sinuous channel of which has a plurality of combination indentations cut at the bottom with a dimension which is a combined function of a plurality of so-called combination parameters, master keying parameters, parameters of transition between longitudinally successive combination indentations and parameters of masking a combination indentation with another non-combination indentation but capable of being interpreted as a combination indentation, as well as the combination parameters of each combination indentation are determined as a function of the length of the pin, of the eccentricity of the active tip of this pin and of a gap not necessarily constant between longitudinally successive pins, and, along the blade. The transition between longitudinally successive combination indentations defines at the bottom a drive track inclined accordingly which is defined by a median line which is capable of passing or not passing through the centers of the combination indentations and which is sinuous both in the direction of the width of the blade and in the direction of the thickness thereof. In this formation, the special feature of the invention is also accomplished, consisting in that in the combination indentations the point of greatest depth belongs to an axis which is off-center with respect to the alignment of pins.

Together with this particular way of positioning the combination indentations, another special feature of the invention is that, in relation to each of the pin-counterpin sets which operate on the combination seatings of the cylinder, the blade is capable of having one or more of a plurality of potential combination indentations which are cut in a variable position and which with different radial distances are contained in a circle which is centered with the operational axis of a plurality of said pin-counterpin sets where the pins have conveniently off-center tips. In each combination seating, they are capable of operating selectively with one of these potential combination indentations. A form of embodiment in this respect is that, for each combination seating of the cylinder, the potential combination indentations cut at the bottom of the irregular sinuous channel, are arranged in the form of at least a first crown, preferably numbering eight, with a displacement of 45° between them, and the centers of which comprise between a minimum diameter of 2 mm and a maximum diameter of 5 mm.

Another form of embodiment is the existence of a second crown of potential combination indentations which is defined by the interior of said first crown and which is similar to the latter in the number and displacement of indentations. According to these special features, in each combination seating the pin can be acting on any one of the potential combination indentations around the operational axis thereof, so by looking at the cylinder through the key entry groove, the view of the pin is not indicative of the place where the combination indentation which is acting as the effective combination indentation will be; also, neither does the view of the key clarify anything in this respect, since there are millions of variations possible and very similar to one another. In practice, therefore, it can be considered impossible to know the exact position of the cut, which determines the combination. In this respect, it should be pointed out that, for each position known in itself of each pin in the cylinder, there exist at least nine possible operative indentations (those assigned to said first crown), very close to one another, on which the tip thereof can operate according to how the latter is oriented. It should be pointed out that in a very usual cylinder, there are two rows of five pins each. It should also be pointed out that the combination indentations cut in the blade are usually made with seven different heights (or depths), as well as it being possible, in the cuts, for the visual diameter on the surface of the blade to have no relationship with the height of the cut, since a useful cutter can be used which, for example, from the third height produces combination indentations of the same diameter in the surface of the blade.

Another distinguishing property of the invention comes from the sinuous trajectory which in the maneuver of inserting the key covers from start to finish the consecutive combination indentations, such that the latter remain linked by means of said drive track inclined accordingly, through machined segments of elimination of material of the blade, enabling the transition between them in adjusting for the correct introduction and functioning of the key in the cylinder.

This means that, above all, in flat keys it will be possible to make the cuts following special and intentionally irregular trajectories (instead of isolated traditional blind conical cuts, for flat keys; or of “V” cuts, for toothed keys) with the aim of improving the action of the key on the pins, reducing friction, as well as avoiding unnecessary movements of pins, enabling the entry and removal of the key to be performed smoothly and easily.

In this respect, it should be borne in mind that, as the revolving pins are not on their axis, the arrangement of cuts around the axis of the pin requires the tips of the pins to be also oriented towards the particular cut on which they have to act, so that when the key is introduced, in addition to the normal friction (between pins and cylinder or cylinder rotor) more friction appears through action of the key in an area of the non-revolving pin which is diverted from the axis thereof.

Another special feature of the invention is that in one or more of the combination seatings existing in the irregular sinuous channel and in relation to at least one of the pin-counterpin sets which operate in the combination seatings of the cylinder, as well as the combination indentation, in this irregular sinuous channel of the blade there exist, at least, two combination indentations which have a different depth. Preferably, in this respect the use of two combination indentations of different depth is provided for, only one of which operates with the eccentric tip (8a) of the pin, which, in the direction of introduction of the blade into the cylinder, is linked with the preceding theoretical combination indentation by means of a single segment of the drive track inclined accordingly.

In this event, the invention also contemplates that only one of these combination indentations operates with the eccentric tip (8a) of the pin, while the other is capable of operating with the eccentric tip (8a) of a pin belonging to another cylinder provided with another opening combination which is compatible with the same key, and in the direction of introduction of the blade into the cylinder. These two combination indentations are linked with the combination indentations of the preceding and following combination seatings by means of respective segments of a forked drive track inclined accordingly, or, of a single segment of the drive track inclined accordingly which starts from an intermediate place between the two combination indentations of the current combination seating.

This capability of the invention enables a dual function: on the one hand, that of the two combination indentations (non-combination indentation) which does not work with the eccentric pin and which, therefore, does not participate in the opening combination cut in the blade in relation to a particular cylinder, performs the function of masking the valid opening combination thereof, thereby misleading a person who may be attempting to breach the cylinder. Moreover, this non-combination indentation for this particular cylinder can act as a combination indentation for opening another cylinder with this same key blade, which performs a function of master keying which, furthermore, proves favorable in the functional capacity thereof, given the enormous number of possible combinations of the proposed key.

In summary, according to this invention, in the cuts of the keys are combined conventional cuts, cuts with special cutters, cuts with special trajectories, cuts with variable depths, cuts with indentations and trajectories which are totally or partially off-center, channels with a trajectory joining indentations with a component which is determined as necessary for the smooth introduction of the key and for establishing the opening code or combination for the pins of the cylinder, plus a mastering trajectory which is made with a special tool to achieve configuration of walls for the irregular channel which does not allow reliable data to be obtained for falsifying the key, giving rise to a visual profile which does not allow the depth of the cut to be read.

The coordination of all of these possibilities means that it is necessary to define a complex algorithm with which the trajectory of the cut of the key must comply, and without which it is very difficult to reproduce the key since, for a given cut in the bit, this algorithm defines the optimum route between two consecutive cuts bearing in mind: a) facilitating the transit of the tips of the pins both on the entry of the key into the cylinder and on the removal, b) respecting the existence of the cuts which are defined in the key, both the active ones and the masking ones, c) accomplishing the first two points removing the minimum amount of material of the key with the aim of not weakening it or cracking it.

Apart from the practical impossibility of copying a key according to the invention through visual observation, direct reading of the key, impression techniques or, also, remote photography. The wide range of possibilities for cutting one of these keys enables numerous arguments endorsing the difficulty of copying to be settled, including:
the variable positions of the cuts of the blades are only defined at the moment of cutting, among the millions of possibilities;
in a sequence of keys the cuts are determined randomly, so that studying the cuts of a series of consecutive keys provides no indication as to how the cut of the following key in the series will be made;
the cutting system proposed involves the use of special cutters, formation of non-centered trajectories and double lines of cut which form channels of variable depth and width in the length thereof, which prevents the cuts of these keys being made with conventional copying machines designed for aligned positions with a constant profile which do not allow transversal working, nor is it possible to produce them with existing digital control machines, due to the non-existence of software programs with suitable algorithms and not knowing which algorithm is the necessary one, among the millions of those possible;
the variable arrangement of the tips of the pins in accordance with the combination indentation chosen for a particular combination, enables a number of possible positions to produce a same visual aspect, making it impossible to know which is the right one;
the special trajectories between combination indentations of the cut of the key prevent minor adjustments being made to defects in fraudulent keys, since the material necessary for the purpose has been removed when making the defective fraudulent copy;
as regards flat keys, these special trajectories resulting from applying a certain algorithm mean that, if they are not formed correctly, when cutting the opposite face of the key the blade will be cut in the area of interference lacking material, if the execution error is made either in the transversal or in the longitudinal direction of the blade of the key; and
the access segments (of the drive track inclined accordingly) between operative indentations must also be produced in a very precise way, since otherwise the key may not be able to enter the cylinder or be extracted by a partial introduction through jamming of the maneuver.

As regards techniques for forcing a lock, according to what is proposed by this invention, the picklock method is rendered impracticable, due to the large number of possible positions of the tips of the pins. The design of sets of “half keys” (jargon) which try to force the cylinder by their insertion one after another is also rendered futile, due to the millions of possible keys for a cylinder according to the invention. They also offer special security against the aforementioned technique of “bumping”.

The content of the invention can also be applied to toothed keys, not just to flat keys, although for the latter the significance of the invention is much greater.

Moreover, although the principal object of the invention is the cutting of keys of locks which prevents the fraudulent copy thereof and, incidentally, provides greater security against the forcing of cylinders which use keys cut in this way, from what has been set out above it is obvious that keys cut according to the invention also provide a considerable increase in combination and master keying capabilities.

### BRIEF DESCRIPTION OF THE SEVERAL VIEWS OF THE DRAWINGS

For a better understanding of the nature of the invention, a form of industrial embodiment is represented in the drawings, which is purely for illustrative purposes and is not exhaustive.

FIG. 1 is an exploded view in perspective in which is illustrated a preferred embodiment of the invention; this includes an enlarged detail view of a pair of semi-pins (6), seen in orthogonal projection from the front of the cylinder (1-2) both in front elevation and from below and from above, as well as an enlarged detail view of the form of the transversal section of an orifice (5), or seating, of any kind, as well as a transversal section of the cylinder (1-2), given by the axis of one of the orifices (5). In this figure the invention is illustrated relating to a flanked or toothed key (3) which has two parallel edges with different cuts between them.

FIG. 1A is an enlargement of the transversal section view of the cylinder (1-2) according to FIG. 1, which incorporates an enlarged detail view of the set of semi-pins (6), with the counterpins (6c) and springs (6d) thereof.

FIG. 2 is an enlargement of the detail view II referred to of the perspective view of FIG. 1.

FIG. 3 is an enlargement of the detail view III referred to of the perspective view of FIG. 1.

FIG. 4 is a partial view of the section IV-IV referred to of the transversal section of the cylinder (1-2) of FIG. 1A.

FIG. 5 shows the lock of FIG. 1 in perspective, but without being exploded.

FIG. 6 shows a perspective view of a different pair of semi-pins (6) like the one included in FIG. 1.

FIG. 7 is a perspective view from below of FIG. 6.

FIG. 8 is a detail view like the one in FIG. 2, but refers to the semi-pins (6) shown in FIGS. 6 and 7.

FIG. 9 is a detail view like the one in FIG. 3, but refers to the semi-pins (6) shown in FIGS. 6 and 7.

FIG. 10 is a transversal section of the cylinder (1-2) like the one included in FIG. 1, but referring to the design of semi-pins (6) shown in FIGS. 6 and 7.

FIG. 11 is like FIG. 4, but refers to the semi-pins (6) shown in FIGS. 6 and 7.

FIG. 12 is a perspective view of a possible one-piece pin (7).

FIGS. 13, 14 and 15 are views in front elevation, from below and above respectively, corresponding to the one-piece pin (7) design shown in FIG. 12.

FIG. 16 is a transversal section of the cylinder (1-2) like the one included in FIG. 1, but refers to the one-piece pin (7) shown in FIG. 12.

The pairs of FIGS. 17-18, 19-20, 21-22 and 23-24 are views in front elevation and from below of a possible orientable one-piece pin (8), showing various orientations of its eccentric tip (8a).

FIGS. 25 to 27 show respective flat keys (4), which are capable of being used according to the invention. The one in FIG. 27 incorporates an enlarged detail view of a singular cut applicable with the invention.

FIG. 28 shows a plan view of a possible orientable one-piece pin (8), showing some of the angular positions (8c) of its eccentric tip (8a) with regard to the rotational axis of the pin.

FIG. 29 is like FIGS. 25 to 27 with an enlarged detail view, which represents the different cuts applicable to the invention.

FIG. 30 is a perspective view showing a key blade (10) cut according to the invention for a median plane (15a) of pins (8) and counterpins (7c) in a cylinder (15) of five combination seatings in which operate respective pin-counterpin sets (8-7c). This FIG. 30 includes an enlargement of an end portion of the blade (10), which is from above in orthogonal projection and which is accompanied by four enlarged sections corresponding to respective sections in which a combination indentation (12) is cut which, in this case, behaves as an effective combination. All the sections are referring to a common median plane (15a) of pins (8) and counterpins (7c).

FIG. 31 shows a sectional view of a possible eccentric pin (8) with its tip in four different eccentric positions referring to one of the possible positions of the paraxial projection (8b).

FIG. 32 is a schematic view of an enlargement of the blade (10) relative to the potential working area of the pin (8) for one of the combination seatings of the cylinder (15), which shows as a dotted line the circle containing (14) a plurality of potential combination indentations (12) which are distributed in two concentric crowns according to axes offset by 45°.

FIG. 33 shows a transversal section of a cylinder (15) for a blade (10) cut according to the invention on which a pin (8) is acting with an eccentric configuration like that shown on the right in FIG. 60.

FIG. 34 is like FIG. 33, but referring to the existence of a dual combination indentation (12) in relation to a same eccentric pin (8).

FIGS. 35 to 38 show schematic views of different configurations of potential operative indentations (12), contained in the more general configuration shown in FIG. 32.

FIGS. 39 to 42 illustrate schematic views of respective possible simple cuts of the blade (10), that is, not yet having formed the irregular sinuous channel (11) or the drive track inclined accordingly (13), using only four of the potential combination indentations (12), which in the containing circle (14) are in the clockwise positions of 45° and 135°, and those diametrically opposite them, as shown in FIG. 38, for example.

FIG. 43 is a schematic view of an enlargement of the detail XLIII ringed in FIG. 40, in which the longitudinal section of the blade (10) has been included corresponding to the combination cut therein.

FIGS. 44 and 45 are like FIG. 43, but showing two successive stages of machining between combination indentations (12) according to the invention; in the jargon, the first of these is called a “decrested cut” and the second an “ideal cut”.

FIG. 46 shows schematic views of respective selective final stages of the cut of the blade (10) of FIGS. 43 to 45, but without including the longitudinal section, which appears in the latter.

FIG. 47 is similar to FIG. 46 but in it we show combination indentations (12) which being formed with a piece with a cylindrical-conical section can produce indentations of different operating depth (12a) for a same apparent diameter (18) as can be appreciated in the sections included which differ from the traditional ones represented in FIG. 30 and make these indentations (12) less visually identifiable.

FIGS. 48A and 48B are a similar perspective to that of FIG. 30, but showing a masking cut. FIG. 48A shows the key formed without masking with only the combination indentations (12a) and FIG. 48B shows the masked key to which have been added the non-combination indentations (12c) solely for the purpose of masking.

FIG. 49 shows schematic view of a simple cut according to the invention.

FIG. 50 is a schematic view of the blade (10) of FIG. 49, but showing a corresponding decrested cut.

FIG. 51 shows a schematic view of the master key cut of the blade (10) of FIG. 49.

FIG. 52 shows a schematic view of the front of the key entry groove in the cylinder (15), enlarged with respect to the size of the blades (10) of FIGS. 49 to 51, exposing the view of the front pin (8) to illustrate the difficulty of guessing on which of the combination indentations (12) they and those which it is hiding behind it are acting.

FIGS. 53 and 54 show respective maskings; the first, on a simple cut according to the invention; the second, on the same cut as in FIG. 53 once decrested.

FIG. 55 is a schematic view of a blade (10) in which one of the combination seatings has a combination indentation (12) cut with a lateral displacement error.

FIG. 56 is an enlargement of the section LVI-LVI that is indicated in FIG. 55.

FIG. 57 is a schematic view of a blade (10) in which one of the combination seatings has a combination indentation (12) cut with a longitudinal displacement error.

FIG. 58 is an enlargement of the section LVIII-LVIII that is indicated in FIG. 57.

FIG. 59 shows in lateral view a toothed key (3) formed according to the invention.

FIG. 60 is an enlargement of the section LX-LX that is indicated in FIG. 59.

FIGS. 60X and 60Y are sections which show the key of FIG. 59 inserted into a lock and acting on the indentations (12x) or (12y) thereof. The detail view of FIG. 60Z shows the different pins which act on the indentations (12x) and (12y) which would be produced along the length of a toothed key.

In these figures the following references are used:

1. Cylinder stator

2. Cylinder rotor

3. Flanked or toothed key

4. Flat key

5. Cylinder seating or orifice (1-2)

5a. Corners in transversal section of orifice (5)

6. Semi-pins

6a. Eccentric tips of semi-pins (6)

6b. Paraxial projection of semi-pins (6)

6c. Counterpin for semi-pins (6)

6d. Spring for counterpins (6c)

7. One-piece pin

7a. Eccentric tips of one-piece pin (7)

7b. Paraxial projections of one-piece pin (7)

7c. Counterpin for one-piece pin (7)

7d. Spring for counterpin (7c)

8. Orientable one-piece pin with a single eccentric tip

8a. Eccentric tip of orientable one-piece pin (8)

8b. Paraxial projections of orientable one-piece pin (8)

8c. Angular positions of eccentric tip (8a)

9. Threaded plug

10. Key blade or bit

11. Irregular sinuous channel

12. Combination indentations in irregular sinuous channel (11)

12a. Maximum depth in combination indentations (12)

12a1. Maximum depth of the combination indentation in this particular example represented

12a2. Maximum depth of the combination indentation in this particular example represented

12a3. Maximum depth of the combination indentation represented in this particular example represented

12a4. Maximum depth of the combination indentation in this particular example represented

12b. Axis of maximum depth (12a)

12c. Non-combination indentation

12x. Indentation in toothed key

12y. Indentation in toothed key

13. Drive track inclined accordingly

13a. Segment of drive track inclined accordingly (13)

14. Circle containing potential combination indentations (12)

15. Cylinder

15a. Median plane of pins (8) in cylinder (15)

16. Area of breakage by cutting with lateral error

17. Area of breakage by cutting with longitudinal error

18. Mouth diameter

### DETAILED DESCRIPTION OF THE INVENTION

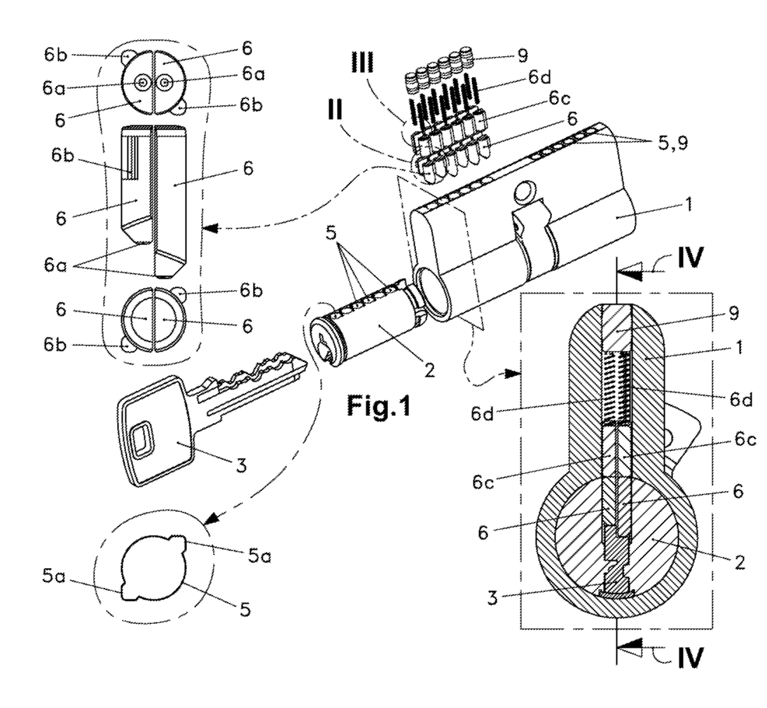

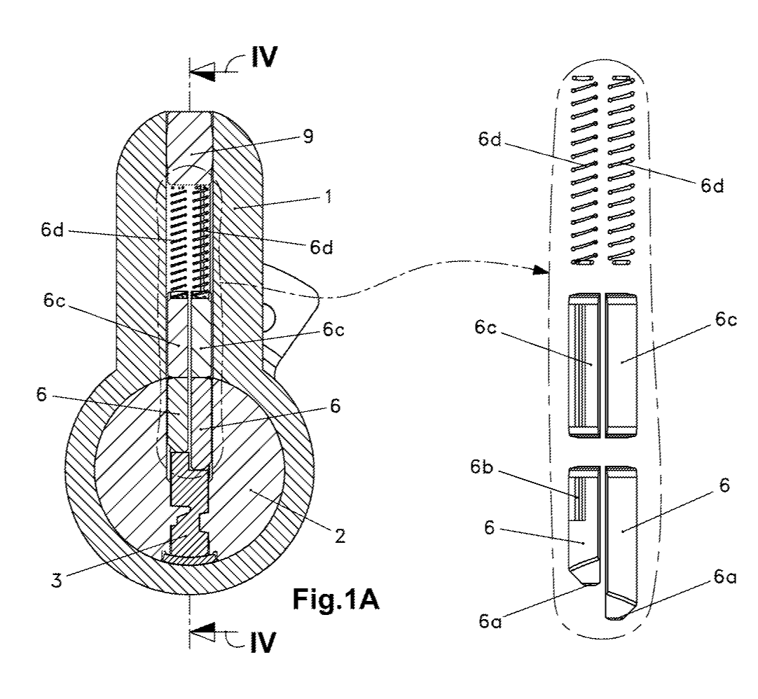

Relating to the drawings and references listed above, a preferred embodiment of the object of the invention is illustrated in the attached plans, referring to a lock with combination pins of non-circular section and eccentricity capable of being positioned in rotation. As FIGS. 1 and 1A to 5 illustrate, it consists in that the seatings or orifices (5) for combination means by pin-counterpin sets are aligned according to the longitudinal median plane of the cylinder (1-2) of the lock, although the invention can also be implemented in cylinders with holes which are displaced with regard to the median plane, on both sides (double row cylinders), and are bored with a transversal section which is not revolved but circumscribed to the cylinder orifice (5) the diameter of which has sliding adjustment with regard to that of conventional revolving pins which do not have a marked rotatory position, and in at least one of these same orifices (5) in the rotor (2) are housed together two semi-pins (6), abutting each other, which are provided with respective eccentric tips (6a). In their combined outline, they are complementary with regard to said transversal section of the orifice (5) which is provided for the purpose through the stator (1) and the rotor (2) of the cylinder (1-2) reaching the key entry channel (2a) in said rotor (2), and of which the eccentric tips (6a) of the pair of semi-pins (6) housed in a same orifice (5) are capable of operating in combination indentations belonging to a same or to two different rows of cuts provided in the shaft of the key. The semi-pins (6) of which have paraxial projections (6b) which are reciprocal to corners (5a) formed in the transversal section of the orifice (5) corresponding to the seating, and where each semi-pin (6) has a counterpin (6c) associated with it which is mounted against a spring (6d) (FIGS. 1 and 1A); in each orifice (5) the mounting is assured by a threaded plug (9).

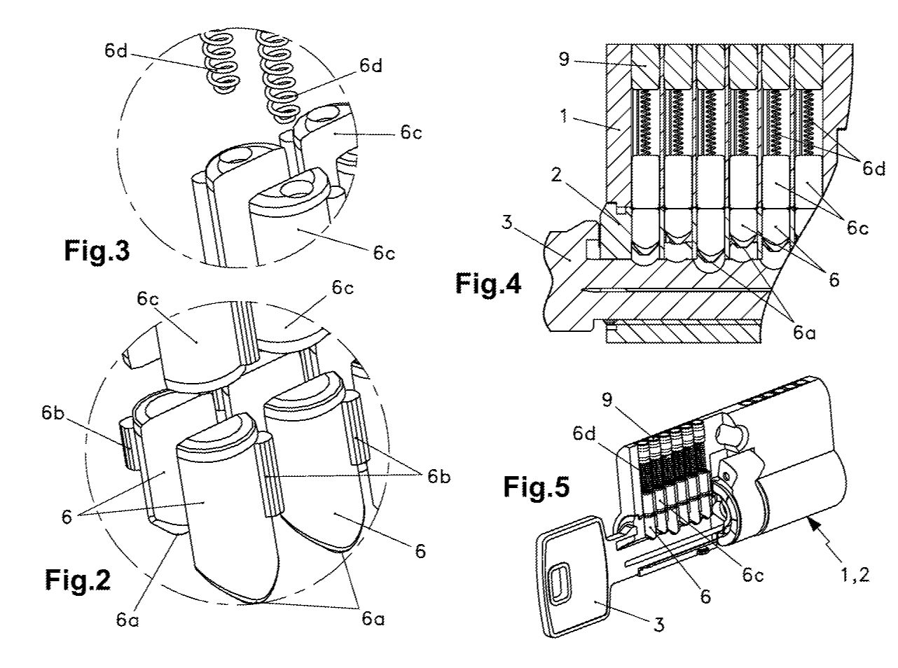

In these FIGS. 1 and 1A to 5 is illustrated an application referring to a toothed key (3) which has two parallel toothed edges and which operates in a cylinder (1-2) in which the semi-pins (6) of each orifice (5) have a different length and, with the exception of its paraxial projections (6b), these two semi-pins (6) together form a cylindrical outline with the diameter of a pin of the conventional type and are abutting each other according to a diametric plane thereof. This cylindrical outline ensures its correct vertical mobility while the paraxial projections (6b) impede the free turning thereof. According to the preferred embodiment shown in these FIGS. 1 and 1A, the paraxial projections (6b) of the pair of semi-pins (6) are mutually in diametric opposition and in any angular position of 360° representing a preferred and non-limitative embodiment of 45° to the diametric plane of their mutual abutment. These forms can be the ones represented, or any other circular or polygonal form, which achieves an adequate anti-turning function at the same time as ensuring correct upward and downward sliding of the pins. Taken together these FIGS. 1 and 1A illustrate the preferred configuration of the semi-pins (6), the mounting thereof in the cylinder (1-2), the form of the transversal section of the orifice (5) of the seating and the internal arrangement in the cylinder (see the transversal and longitudinal sections thereof, and FIGS. 2 and 3), where each semi-pin (6) has a counterpin (6c) associated with it which is mounted against a spring (6d). Looking at these figures highlights the number of possible positions which can be adopted by the eccentric tip (6a) of each semi-pin (6), or the paraxial projections (6b), as well as the facility for each of them to operate on two different alignments of cuts of the toothed key (3). In this respect, according to the invention, said eccentric tips (6a) of the pair of semi-pins (6) of a same orifice (5) are capable of operating in combination indentations belonging to a same or to two different rows of cuts provided in two parallel edges of a same flanked key (3). As in addition (FIGS. 25 to 27) said eccentric tips (6a) of the pair of semi-pins (6) of a same orifice (5) are capable of operating in combination indentations belonging to a same or to two different rows of cuts provided in a larger face of the shaft of a flat key (4).

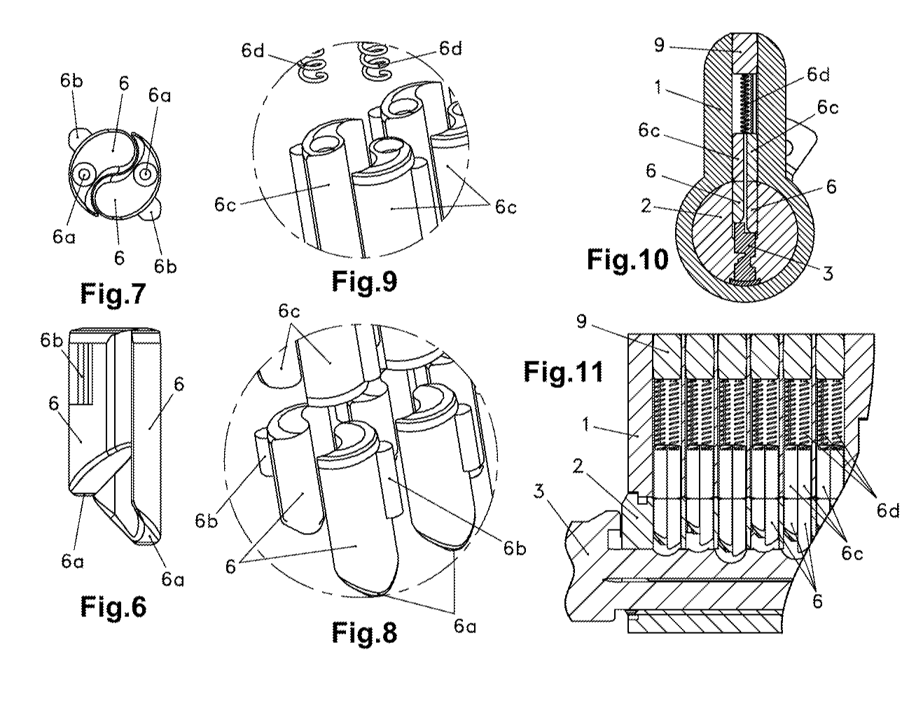

An alternative embodiment is the one illustrated by FIGS. 6 to 11, where the semi-pins (6) of each orifice (5) have a different length and, with the exception of their paraxial projections (6b), the two semi-pins (6) together form a cylindrical outline with the diameter of a pin of the conventional type and are abutting each other according to a sinusoidal plane which spans a complete period. In the same way as in the preceding configuration, according to a preferred embodiment of the invention, said paraxial projections (6b) of the pair of semi-pins (6) are mutually in diametric opposition and preferably at 45° to the longitudinal plane which contains the axes of the active respective eccentric tips (6a) thereof. Similarly (FIGS. 9 to 11), each semi-pin (6) has a counterpin (6c) associated with it which is mounted against a spring (6d).

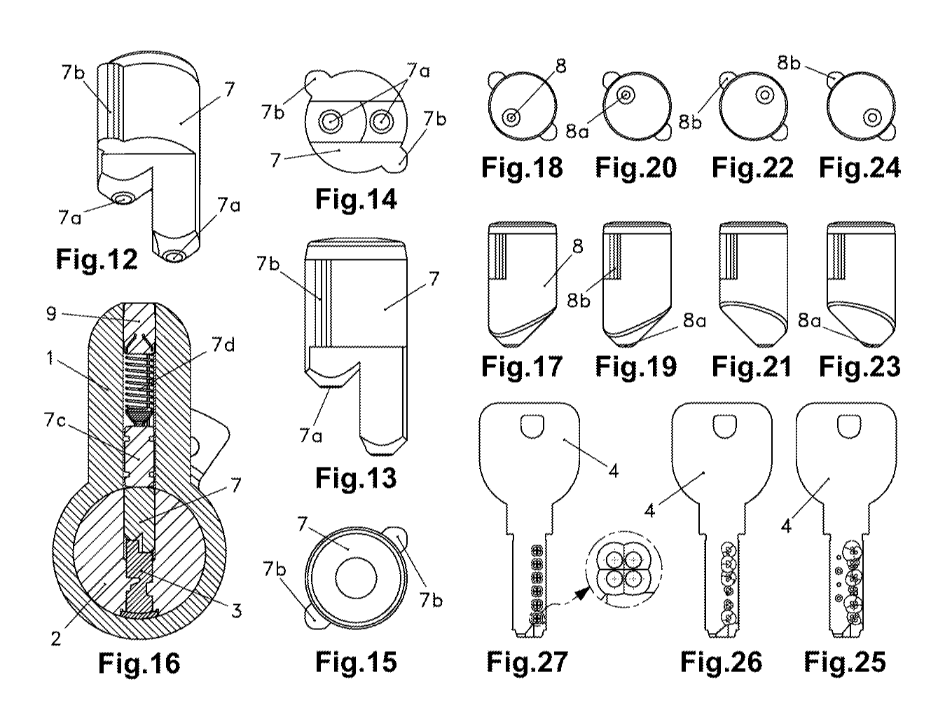

Another embodiment of the invention (FIGS. 12 to 16) consists in the semi-pins (6) of a same orifice (5) being integrated in a one-piece pin (7) provided with two eccentric tips (7a) which are capable of operating in combination indentations belonging to a same or to two different rows of cuts provided in the shaft of the key; with the exception of the paraxial projections (7b). The one-piece pin (7) has a cylindrical periphery with the diameter of a pin of the conventional type and has its two eccentric tips (7a) which can be staggered in a longitudinal direction or an eccentric tip (8a) in angular positions (8c) with regard to the rotational axis of the pin. According to a preferred embodiment, said paraxial projections (7b) of the one-piece pin are (FIGS. 14 and 15) in mutual diametric opposition and preferably at 45° to the longitudinal plane which contains the axes of said eccentric tips (7a). As in the cases described above, said eccentric tips (7a) of the one-piece pin (7) are capable of operating in combination indentations belonging to a same or to two different rows of cuts provided in two parallel edges (FIG. 16) of a same flanked key (3); or also, said eccentric tips (7a) of the one-piece pin (7) are capable of operating in combination indentations belonging to a same or to two different rows of cuts provided in a larger face of the shaft of a flat key (4). In FIG. 16 it can be seen that each one-piece pin (7) has a counterpin (7c) associated with it which is mounted against a spring (7d).

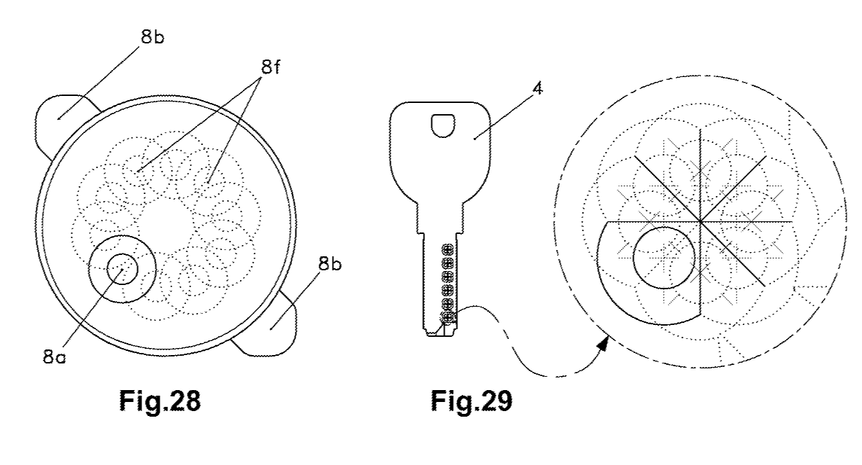

FIGS. 17 to 24 and 28 show an orientable one-piece pin (8) and with a single eccentric tip (8a) as an illustration of the large variety of types of pin which can be used interchangeably in the lock system according to the invention. In this orientable one-piece pin (8) its eccentric tip (8a) is capable of operating on any of the indentations grouped in a two by two square of the flat key (4) of FIG. 27 simply by mounting it in one or other of the orientations shown in the pairs of FIGS. 17-18, 19-20, 21-22 and 23-24. As is obvious, this orientable one-piece pin (8), like the other types described above, can also operate in relation to the cuts, which, for illustrative purposes, are shown in the flat keys (4) of FIGS. 25, 26 and 29. The eccentric tips (6a, 7a, 8a) are capable of operating in combination indentations belonging to a same or to multiple different rows of cuts provided in a larger face of the shaft of a flat key (4).

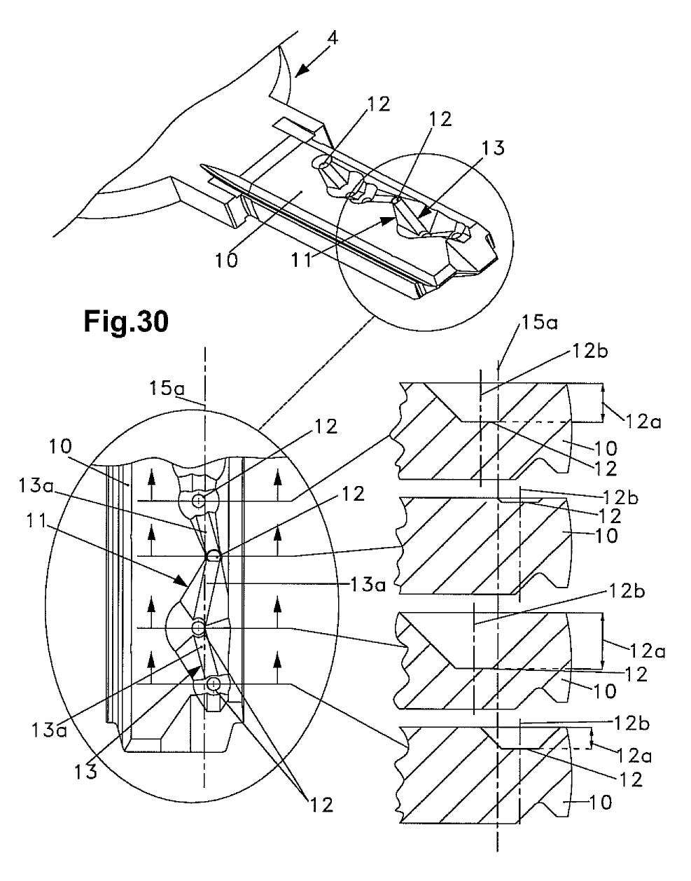

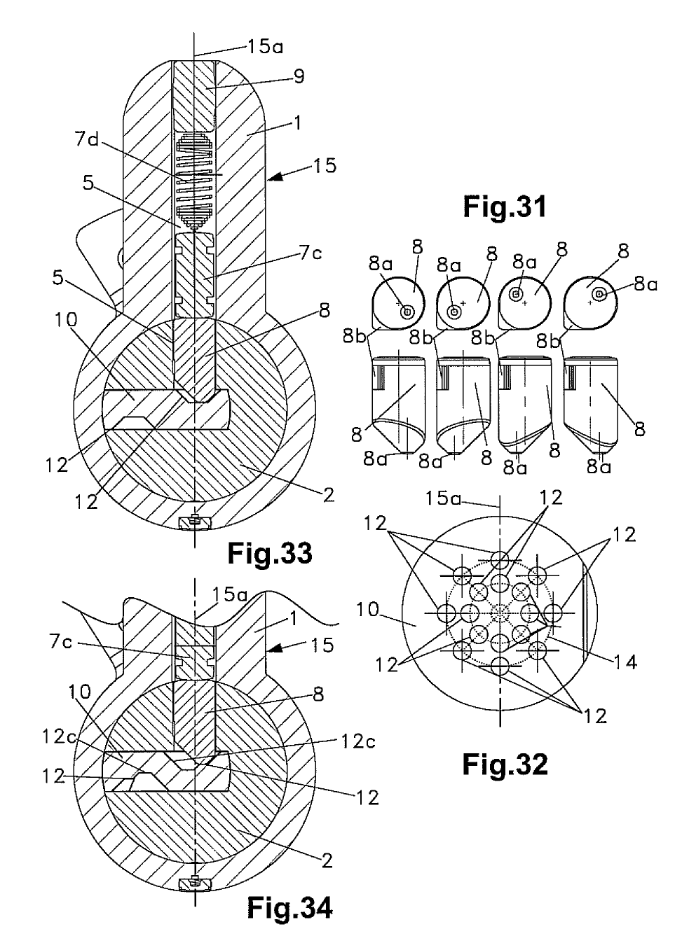

Relating to the drawings and references listed above, a preferred embodiment of the object of the invention is illustrated in the attached plans, referring to a lock key with indentations difficult to reproduce fraudulently, of the type which have at least one row of combination seatings which operate with the pin-counterpin sets (8-7c) housed in the orifices of the cylinder (15), comprising a stator (1) and a rotor (2), and designating a median plane (15a) of pins and counterpins to the plane which contains the axes of the cylindrical part thereof (8-7c) and which would also be the plane which would contain the combination indentations (12) of the key, if the pins (8) were not off-center on their active tip, which, in the blade (10) of the key an irregular sinuous channel (11) is cut with respect to the median plane (15a) of pins (8). This channel (11) in each transversal section has a variable width and, at least, a variable depth of independent size between them. The irregular sinuous channel (11) of which has a plurality of combination indentations (12) cut at the bottom with a dimension which is a combined function of a plurality of pre-determined combination parameters, master keying parameters, parameters of transition between longitudinally successive combination indentations (12) and parameters of masking a combination indentation (12) with another non-combination indentation (12c) but capable of being interpreted as a combination indentation (12), as well as the combination parameters of each combination indentation (12) are determined as a function of the length of the pin, (8) of the eccentricity of the active tip of this pin (8) and of a gap not necessarily constant between longitudinally successive pins (8), and, along the blade (10). The transition between longitudinally successive combination indentations (12) defines at the bottom of the channel a drive track inclined accordingly (13), which is defined by a median line which is capable of passing or not passing through the centers of the combination indentations (12) and which is sinuous both in the direction of the width of the blade (10) and in the direction of the thickness thereof. In this FIG. 30 is also highlighted a special feature of the invention consisting in that in the combination indentations (12) the point of greatest depth (12a) belongs to an axis (12b) which is off-center with respect to the median plane (15a) of pins (8) and counterpins (7c).

Another special feature of the invention is that, in relation to each of the pin-counterpin sets (8-7c) which operate in the combination seatings of the cylinder (15), the blade (10) is capable of having one or more of a plurality of potential combination indentations (12) which are cut in a variable position and which with different radial distances are contained in a circle (14) which is centered with the operational axis of a plurality of said pin-counterpin sets (8-7c) where the pins (8) have conveniently off-center tips and which, in each combination seating, are capable of operating selectively with one of these potential combination indentations (12).

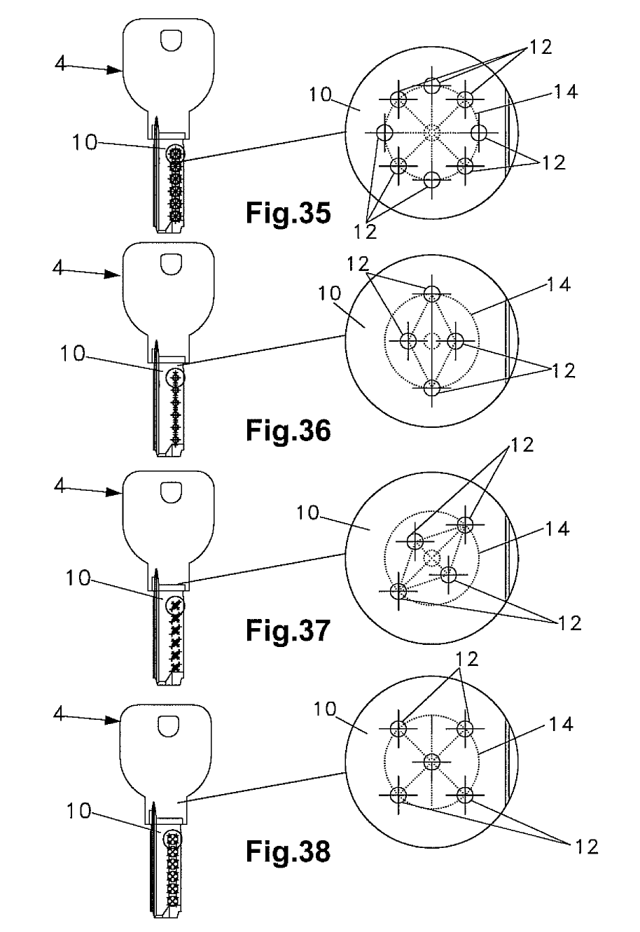

According to a preferred embodiment, in each combination seating the potential combination indentations (12) cut at the bottom of the irregular sinuous channel (11), are arranged (FIG. 32) in the form of at least a first crown, preferably numbering eight, with a displacement of 45° between them. The centers of which comprise between a minimum diameter of 2 mm and a maximum diameter of 5 mm. The existence of a second crown of potential combination indentations (12) being provided for which is defined by the interior of said first crown and which is similar to the latter in the number and displacement of indentations. In FIG. 32, the more general case of arranging the two crowns of potential combination indentations (12) is represented, but, bearing in mind that the essence of the Patent is not the particular distribution thereof, but the manner of using them in conjunction with the irregular sinuous channel (11) and the drive track inclined accordingly (13), within the scope of this Patent any arrangement of potential combination indentations (12) is included, for example, those included in FIGS. 35 to 38.

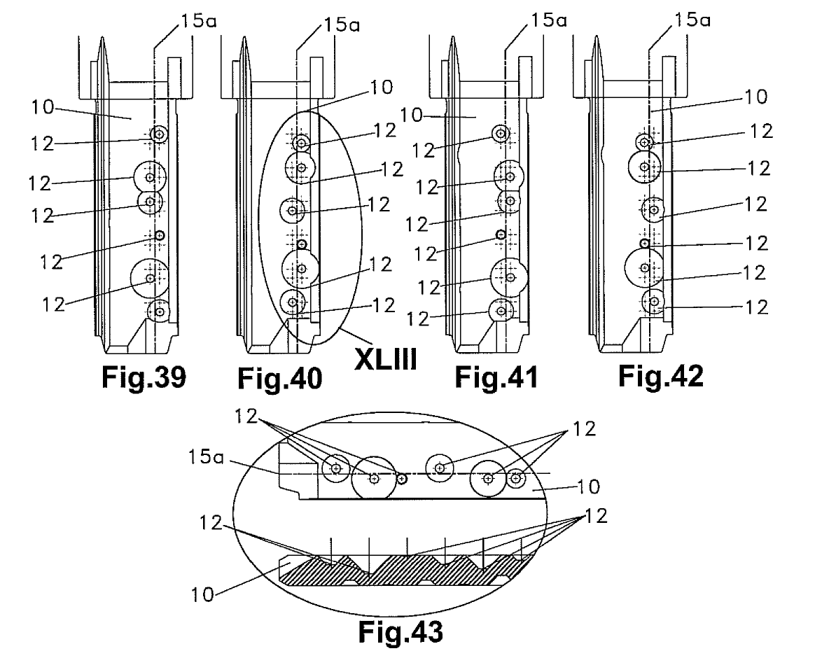

To clearly illustrate the wide possibilities of different ways of cutting a key blade (10) for operating with pins which are aligned in the cylinder (15) in a usual way, FIGS. 39 to 42 show some based on using only four of the potential combination indentations (12) (FIG. 38) [those which in the containing circle (14) are in the clockwise positions of 45° and 135°, and those diametrically opposite thereto] and with only five depths or heights of cut of each combination indentation (12) (it is quite usual to work with seven possible heights). In these FIGS. 39 to 42 the blades (10) are formed with simple cuts, where as stated only alternative positions and heights of the combination indentations (12) are used, the profile of the cut being viewable in the enlarged detail of FIG. 43.

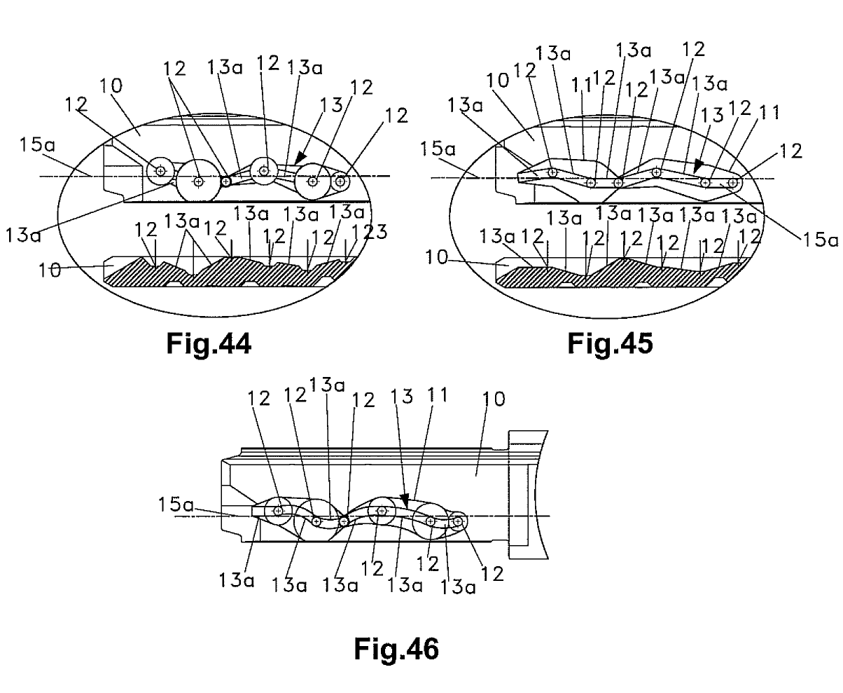

Another special feature of the invention is that, in the drive track inclined accordingly (13) of the irregular sinuous channel (11), the consecutive combination indentations (12) are linked by means of machined segments (13a) of elimination of material of the blade (10) which enable the transition between them in adjusting the key's correct introduction and functioning in the cylinder (15). These machined linking segments (13a) between the combination indentations (12) produce what is called “decresting” and which consists of a studied elimination of material which, on the one hand, enables the smooth entry of the key eliminating the normal friction and the new rotary type which is due to the diverted positions of the tips of the pins, and, on the other hand, said elimination of material impedes correction of errors produced in fraudulent copies of the keys, given that the material has been removed. This issue is illustrated by means of FIG. 44.

A further step in doing the cutting according to the invention is that shown in FIG. 45, showing an already formed irregular sinuous channel (11) with the profusion of widths and depths made randomly and freely, enabling large widths to co-exist with large or small depths, and vice versa, with the particular feature that a width and depth of channel for a combination seating does not allow it to be known where the combination indentation (12), on which the tip of the pin will act, will be. The irregular sinuous channel (11) of FIG. 45 corresponds to what is known as an “ideal” cut and is defined by segments on the basis of which it is possible to adjust curves by means of mathematical interpolation by so-called “spline” methods which make it possible to “smooth” the outline achieving smooth fits between contiguous machined segments (13a) which are initially rectilinear; this leads to the configuration of FIG. 46.

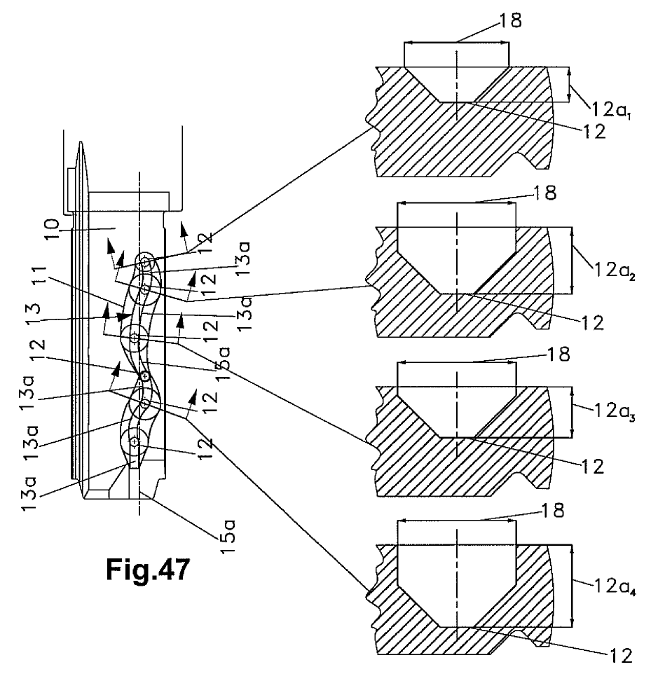

An alternative to this, which makes it even more difficult to fraudulently copy, is that in FIG. 47, where a cutter of suitable cylindrical-conical section has been used with which it is possible to cut combination indentations (12) which, having a different depth, produce in the face of the blade (10) a same mouth diameter (18).

Another particular feature of the invention is that, in relation to at least one of the pin-counterpin sets (8-7c) which operate in the combination seatings of the cylinder (15), in the irregular sinuous channel (11) of the blade (10) there exist, at least, two combination indentations (12) which have a different depth. A preferred embodiment in this respect is to have two combination indentations (12) which have a different depth. In this regard, the invention contemplates that, in relation to the pin-counterpin set (8-7c) of the combination seatings of the cylinder (15) which in the blade (10) are provided with two combination indentations (12) with different depths, only one of these operates with the eccentric tip (8a) of the pin (8), which, in the direction of introduction of the blade (10) into the cylinder (15), is linked with the preceding combination indentation (12) by means of a single segment (13a) of the drive track inclined accordingly (13). Likewise, according to the invention, in relation to the pin-counterpin set (8-7c) of the combination seatings of the cylinder (15) which in the blade (10) are provided with two combination indentations (12) with different depths, one of these operates with the eccentric tip (8a) of the pin (8), while the other is capable of operating with the eccentric tip (8a) of a pin (8) belonging to another cylinder (15) provided with another opening combination which is compatible with the same key, and in the direction of introduction of the blade (10) into the cylinder (15). These two combination indentations (12) are linked with the combination indentations (12) of the preceding and following combination seatings by means of respective segments (13a) of a forked drive track inclined accordingly (13), or of a single segment (13a) of the drive track inclined accordingly (13) which starts from an intermediate place between the two combination indentations (12) of the current combination seating.

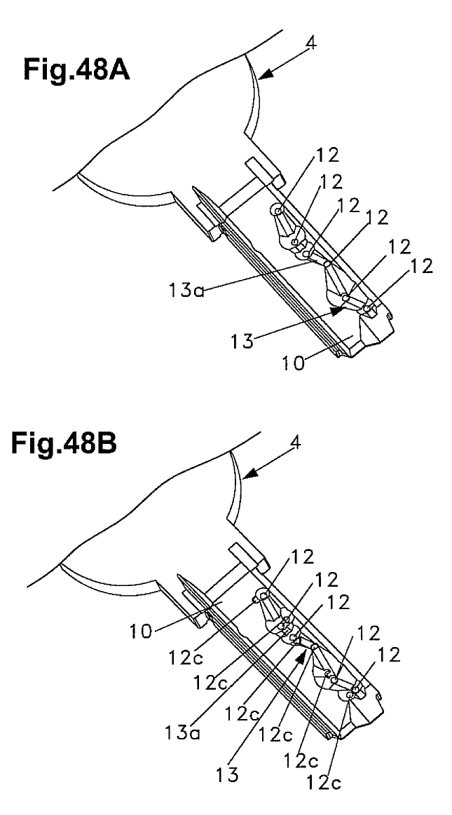

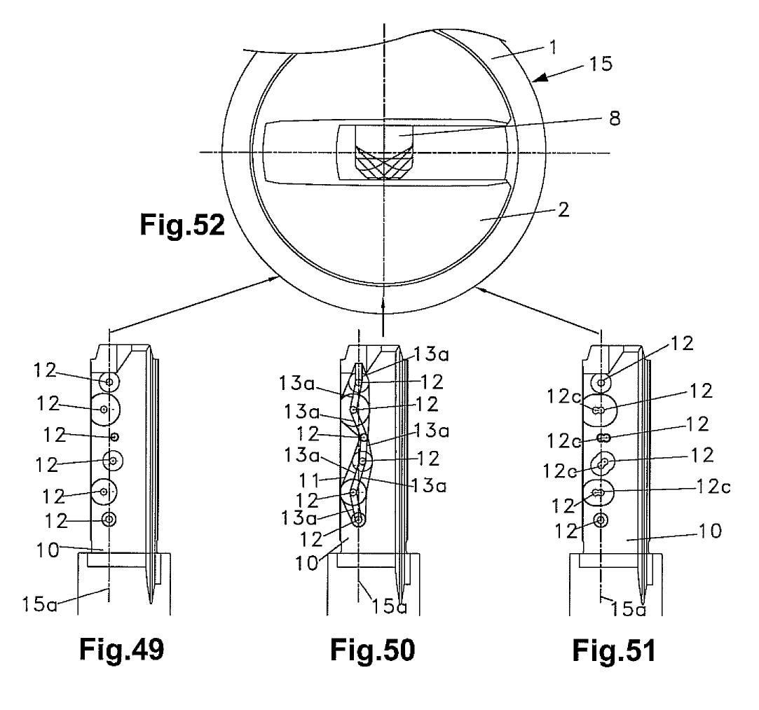

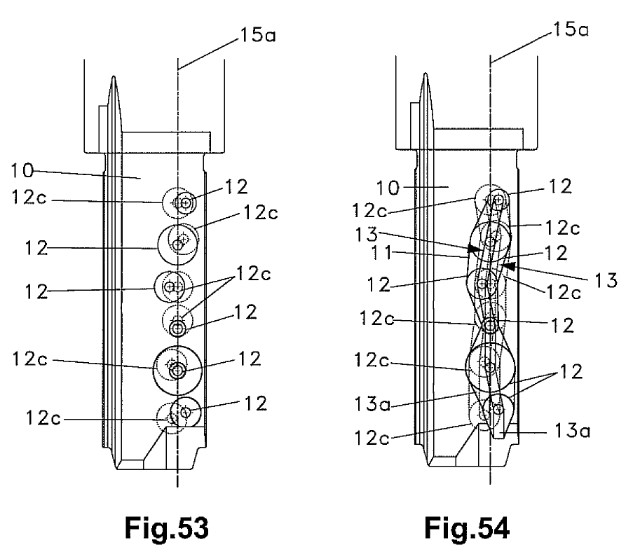

This arrangement is illustrated in FIG. 34, where it can be seen that the pin (8) has its tip sitting in the combination indentation (12) and that there is a non-combination indentation (12c) which can have a function of masking the opening code or which can be used for master keying, using the same key blade (10) to open another cylinder (15). Other graphical representations in this respect are those of FIGS. 48 (A and B) and 49 to 52, where FIGS. 49 (simple cut), 50 (decrested cut) and 51 (masked cut, the one providing the new property), in relation to FIG. 52, highlight the fact that looking at the key entry groove it can be seen that only the front pin (8), without being able to tell the direction of its tip and, much less, how those which are hidden behind it are oriented. In addition, FIGS. 53 and 54 show a blade (10) with the same opening combination. The first, referring to a simple masked cut, and the second, to the same masked but decrested cut, the latter enabling one to appreciate the difficulty it presents in making a fraudulent copy, including a legal copy, as set out above, it requires very special equipment and resources, as it cannot be made with the means currently in use.

Another particular feature of the invention is that the potential combination indentations (12) are capable of operating with pins belonging to pin-counterpin sets (8-7c) which incorporate elements of master keying, it being necessary to point out in this respect that the capabilities of master keying and combination locks are thereby enhanced.

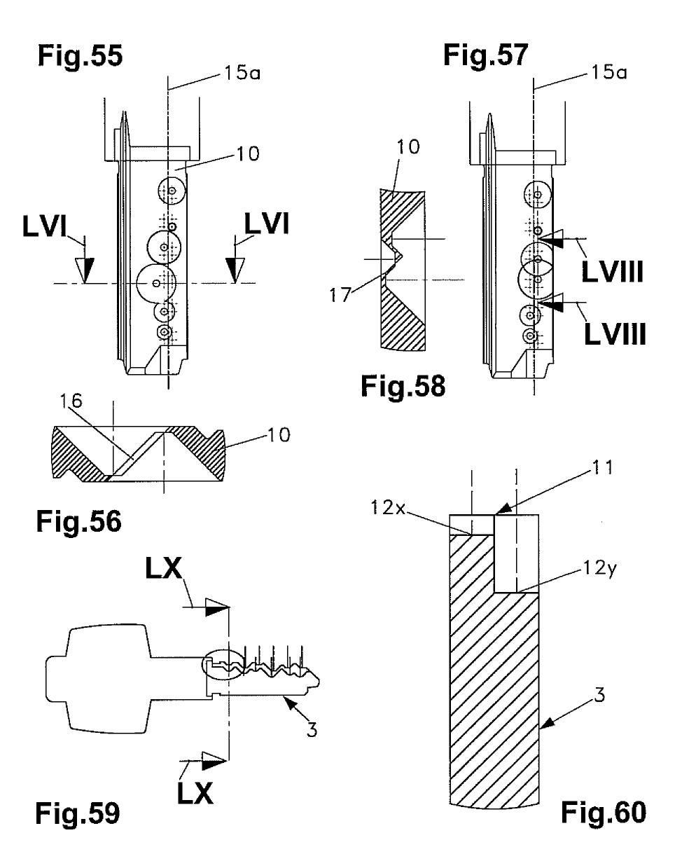

As the potential combination indentations (12) are so close, the slightest error in forming a fraudulent copy causes the blade (10) to break when cutting the opposite face through lack of material. When the error is produced (FIG. 55) in the transversal direction of the blade (10), the area of breakage (16) appears as seen in FIG. 56; if the error is produced (FIG. 57) in the longitudinal direction, the area of breakage (17) appears (FIG. 58).

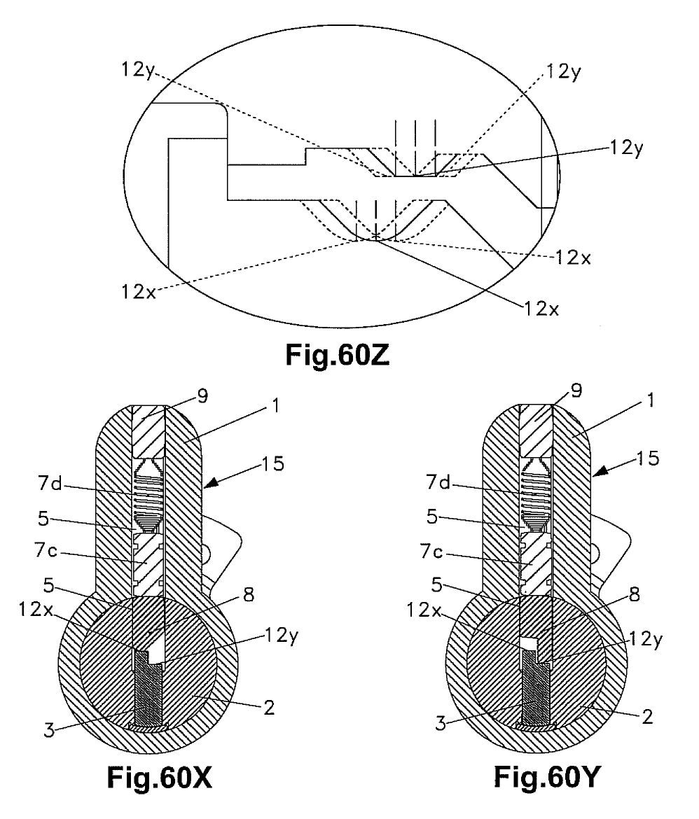

The invention is also applicable to keys with combination indentations in their flank known as toothed keys with the logical limitation that it imposes the narrow thickness available for forming the irregular sinuous channel (11). FIG. 59 represents a toothed key (3) according to the invention, which, as shown in FIG. 60, is specific to the case in that the irregular sinuous channel (11), with the non-rectilinear trajectory which may be chosen, has two different depths in a section in which these depths are in two equal halves of the thickness of the blade (10).

Likewise, it is also possible to make at least three cuts of equal or different depth in accordance with the length of the pin operating on it, in axial arrangement in reference to the longitudinal axis of the key for each of the traditional notches. On the first of them, a pin would operate the axis of the tip of which is forward on the longitudinal axis of the pin. Another possibility is that the axis of the tip coincides with the longitudinal axis of the pin, and a third possibility is that the said axis of the pin is behind with respect to the longitudinal axis.

The plurality of potential combination indentations (12) which are cut in a variable position and which with different radial distances are also implemented on the flank of so-called toothed keys thereby establishing, for each theoretical arrangement of coded pin, two possible areas of right and left cut, in the direction of said flank of the key and for each one of them, at least three other different positions as a function of the relative position of the axis of the tip of the pin which operates on said indentation with respect to the longitudinal axis of said pin: forward, coinciding or behind.

Partial implementation of the invention is provided for more basic or economic implementations, as well as the application thereof to all the combination positions of keys or only to part thereof.

1. Lock with combination pins of non-circular section and eccentricity capable of being positioned in rotation, said lock comprising:
housing orifices for combination means by pin-counterpin sets are bored with a transversal section which is not circular but circumscribed to the cylinder orifice the diameter of which has a sliding adjustment with regard to that of conventional revolving pins which do not have a marked rotatory position, and in at least one of these same orifices
a rotor, the orificed being in the rotor; and
two semi-pins housed together, abutting each other, which are provided with respective eccentric tips and which in their combined outline are complementary with regard to said transversal section of the orifice which is provided for the purpose through the stator and the rotor of the cylinder reaching the key entry channel in said rotor, and of which the eccentric tips of the pair of semi-pins housed in a respective orifice are capable of operating in combination indentations belonging to a same or two different rows of cuts provided in the shaft of the key, and the semi-pins of which have paraxial projections which are reciprocal to corners formed in the transversal section of the orifice corresponding to the seating, and where each semi-pin has a counterpin associated with it which is mounted against a spring.

2. Lock with combination pins of non-circular section and excentricity capable of being positioned in rotation, according to claim 1, wherein the semi-pins of each orifice have a different length and, with the exception of their paraxial projections, these two semi-pins together form a cylindrical outline with the diameter of a circular pin of the conventional type and are abutting each other according to a diametric plane thereof.

3. Lock with combination pins of non-circular section and excentricity capable of being positioned in rotation, according to claim 2, wherein said paraxial projections of the pair of semi-pins are mutually in diametric opposition and in any angular position of the diametric plane of their mutual abutment.

4. Lock with combination pins of non-circular section and excentricity capable of being positioned in rotation, according to claim 1, wherein the semi-pins of each orifice have a different length and, with the exception of their paraxial projections, the two semi-pins together form a cylindrical outline with the diameter of a pin of the conventional type and are abutting each other according to a sinusoidal plane which spans a complete period.

5. Lock with combination pins of non-circular section and excentricity capable of being positioned in rotation, according to claim 4, wherein said paraxial projections of the pair of semi-pins are mutually in diametric opposition and preferably at 45° to the longitudinal plane which contains the axes of their respective active eccentric tips.

6. Lock with combination pins of non-circular section and excentricity capable of being positioned in rotation, according to claim 1, wherein said eccentric tips of the pair of semi-pins of a same orifice are capable of operating in combination indentations belonging to a same or to two different rows of cuts provided in two parallel edges of a same flanked key.

7. Lock with combination pins of non-circular section and excentricity capable of being positioned in rotation, according to claim 1, wherein said eccentric tips of the pair of semi-pins of a same orifice are capable of operating in combination indentations belonging to a same or to two different rows of cuts provided in a larger face of the shaft of a flat key.

8. Lock with combination pins of non-circular section and excentricity capable of being positioned in rotation, according to claim 1, wherein the semi-pins of a same orifice are integrated in a one-piece pin provided with two eccentric tips which are capable of operating in combination indentations belonging to a same or to two different rows of cuts provided in the shaft of the key, and of which the one-piece pin has paraxial projections which are reciprocal of corners formed in the transversal section of the orifice corresponding to the seating, and where each one-piece pin has a counterpin associated with it which is mounted against a spring.

9. Lock with combination pins of non-circular section and excentricity capable of being positioned in rotation, according to claim 8, wherein, with the exception of the paraxial projections, the one-piece pin has a cylindrical periphery with the diameter of a circular pin of the conventional type and has two eccentric tips which can be staggered in a longitudinal direction or an eccentric tip in angular positions with regard to the rotational axis of the pin.

10. Lock with combination pins of non-circular section and eccentricity capable of being positioned in rotation, according to claim 8, wherein said paraxial projections of the one-piece pin are in mutual diametric opposition and preferably at 45° to the longitudinal plane which contains the axes of said eccentric tips.

11. Lock with combination pins of non-circular section and eccentricity capable of being positioned in rotation, according to claim 8, wherein said eccentric tips of the one-piece pin are capable of operating in combination indentations belonging to a same or to two different rows of cuts provided in two parallel edges of a same flanked key.

12. Lock with combination pins of non-circular section and eccentricity capable of being positioned in rotation, according to claim 8, wherein said eccentric tips of the one-piece pin are capable of operating in combination indentations belonging to a same or to two different rows of cuts provided in a larger face of the shaft of a flat key.

13. Lock with combination pins of non-circular section and eccentricity capable of being positioned in rotation, according to claim 1, wherein said excentric tips are capable of operating in combination indentations belonging to a same or to multiple different rows of cuts provided in a larger face of the shaft of a flat key.

14. Lock key with combination indentations difficult to reproduce fraudulently, the lock key comprising:
at least one row of combination seatings;
pin-counterpin sets housed in the orifices of the cylinder and operating the combination seatings, each pin-counterpin set comprising.
a stator; and
a rotor designating a median plane 0f pins and counterpins to the plane which contains the axes of the cylindrical part thereof and which would also be the plane which would contain the combination indentations of the key, if the pins were not off-centre on their active tip, characterised in that,
in the blade of the key an irregular sinuous channel is cut with respect to the median plane of pins, this channel in each transversal section has a variable width and, at least, a variable depth of independent size between them, the irregular sinuous channel of which has a plurality of combination indentations cut at the bottom with a dimension which is a combined function of a plurality of pre-determined combination parameters, master keying parameters, parameters of transition between longitudinally successive combination indentations and parameters of masking a combination indentation with another non-combination indentation but capable of being interpreted as a combination indentation, as well as the combination parameters of each combination indentation are determined as a function of the length of the pin of the eccentricity of the excentric tip or active tip of the pin and of a gap not necessarily constant between longitudinally successive pins, and, along the blade, the transition between longitudinally successive combination indentations defines at the bottom of the channel a drive track inclined accordingly.

15. Lock key with combination indentations difficult to reproduce fraudulently, according to claim 14, wherein the irregular sinuous channel is defined by a median line which is capable of either passing or not passing through the centres of the combination indentations and which is sinuous both in the direction of the width of the blade and in the direction of the thickness thereof.

16. Lock key with combination indentations difficult to reproduce fraudulently, according to claim 14, wherein the irregular sinuous channel has a constant width when it is formed with a tool with a cylindrical-conical section profile which produces an independent mouth diameter with respect to the depth of the indentation of the channel.

17. Lock key with combination indentations difficult to reproduce fraudulently, according to claim 14, wherein, in relation to each of the pin-counterpin sets which operate on the combination seatings of the cylinder, the blade is capable of having one or more of a plurality of potential combination indentations which are cut in a variable position and which with different radial distances are contained in a circle which is centred with the operational axis of a plurality of said pin-counterpin sets where the pins have conveniently off-centre tips and which, in each combination seating, are capable of operating selectively with one of these potential combination indentations.

18. Lock key with combination indentations difficult to reproduce fraudulently, according to claim 14, wherein, in the combination indentations, a point of greatest depth belongs to an axis which is off-centre with respect to the median plane of pins.

19. Lock key with combination indentations difficult to reproduce fraudulently, according to claim 14, wherein, in relation to at least one of the pin-counterpin sets which operate in the combination seatings of the cylinder in the irregular sinuous channel of the blade there exist, at least, two combination indentations which have a different depth.

20. Lock key with combination indentations difficult to reproduce fraudulently, according to claim 19, wherein, in relation to the pin-counterpin set of the combination seatings of the cylinder which in the blade are provided with two combination indentations with different depths, only one of these operates with the excentric tip of the pin, which, in the direction of introduction of the blade into the cylinder, is linked with the preceding combination indentation by means of a single segment of the drive track inclined accordingly.

21. Lock key with combination indentations difficult to reproduce fraudulently, according to claim 19, wherein, in relation to the pin-counterpin set of the combination seatings of the cylinder which in the blade are provided with two combination indentations with different depths, one of the se operates with the excentric tip of the pin, while the other is capable of operating with the excentric tip of a pin belonging to another cylinder provided with another opening combination which is compatible with the same key, and in the direction of introduction of the blade into the cylinder these two combination indentations are linked with the combination indentations of the preceding and following combination seatings by means of respective segments of a forked drive track inclined accordingly, or, of a single segment of the drive track inclined accordingly which starts from an intermediate place between the two combination indentations of the current combination seating.

22. Lock key with combination indentations difficult to reproduce fraudulently, according to claim 17, wherein in each combination seating the potential combination indentations cut at the bottom of the irregular sinuous channel, are arranged in the form of at least a first crown, preferably numbering eight, with a displacement of 45° between them, and the centres of which comprise between a minimum diameter of 2 mm and a maximum diameter of 5 mm.

23. Lock key with combination indentations difficult to reproduce fraudulently, according to claim 22, wherein a second crown of potential combination indentations exists which is defined by the interior of said first crown and which is similar to the latter in the number and displacement of indentations.

24. Lock key with combination indentations difficult to reproduce fraudulently, according to claim 14, wherein partial implementation of the invention is provided for more basic or economic embodiments, as well as the application thereof to all the combination positions of the keys or only a part thereof.

25. Lock key with combination indentations difficult to reproduce fraudulently, according to claim 14, wherein the plurality of potential combination indentations which are cut in a variable position and which with different radial distances are also implemented on the flank of so-called toothed keys thereby establishing, for each theoretical arrangement of coded pin, two possible areas of right and left cut, in the direction of said flank of the key and for each one of them, at least three other different positions as a function of the relative position of the axis of the tip of the pin which operates on said indentation with respect to the longitudinal axis of said pin: forward, coinciding or behind.

26. Lock key with combination indentations difficult to reproduce fraudulently, according to claim 14, wherein in the combination indentations provision is made for the point of greatest depth to belong to an axis which is eel centered with respect to the median plane of pins.
